(19) United States
(12) Patent Application Publication
(10) Pub. No.: US 2008/0007628 A1
(43) Pub. Date: Jan. 10, 2008

(54) Adaptive CCTV camera system

(75) Inventor: Wen-Hsiung Hsieh, Sanchung City (TW)

Correspondence Address: TROXELL LAW OFFICE PLLC;SUITE 1404, 5205 LEESBURG PIKE, FALLS CHURCH, VA, 22041, US

(73) Assignee: Pei Tsai Infosystems Inc.

(21) Appl. No.: 11/481,950

(22) Filed: Jul. 7, 2006

(51) Int. Cl. H04N 5/228

(52) U.S. Cl. 348/222.1

(57) ABSTRACT

The present invention provides an adaptive CCTV camera system that includes an optical sensing unit, an image processing unit, an optical lens set, a memory unit, a microprocessor and at least one automatic control unit. With this structural configuration, the microprocessor which is respectively connected with the image processing unit and at least one automatic control unit, executes the logic program coded in the microprocessor and automatically generates the adjusting information as a correcting reference toward the pre-specified operating parameters stored in the memory unit. Thus, the optimum set of operating parameters is formed in the image processing unit for further operation free of manual adjustments.

Therefore, the present invention facilitates use in various environment and conditions, and provides stable image capture function.

### BACKGROUND OF THE INVENTION

(a) Field of the Invention

The present invention relates to an adaptive CCTV (Closed Circuit Television) camera system, and more particularly to a structural configuration that includes an optical sensing unit, an image processing unit, an optical lens set, a microprocessor, a memory unit and at least one automatic control unit, which provides storing and real-time automatic adjustment of pre-specified operating parameters to achieves stable image capture functionality and effectiveness under different environments such as daytime, evening, night, indoors, outdoors, and so on.

(b) Description of the Prior Art

CCTV camera system of prior art (see FIG. 1) are primarily assembled from an optical sensing unit 10, an image processing unit 20, an optical lens set 30, a memory unit 40, a microprocessor 50 and a manual control unit 60, wherein the optical sensing unit 10 is able to capture images and the image processing unit 20 processes image signals received from the optical sensing unit 10 and produces image output. The optical lens set 30 projects optical signals to the optical sensing unit 10. The memory unit 40 stores a set of pre-specified operating parameters. The manual control unit 60 is used as an interface to manually input control signals. The microprocessor 50 receives signal from the manual control unit 60 to change the value of operating parameters. Although the aforementioned CCTV camera system of prior art is able to capture images, however, in order to enable the CCTV camera system to be applied in different environmental conditions or circumstances, a user therefore have to constantly and manually adjust certain set of operating parameters stored in the memory unit 40 to fit actual solution. Under such a circumstance, the parameter settings will be inadequate for cameras working 24 hours a day in varied seasons, places and regions. Moreover, the CCTV camera systems of prior art are unable to provide stable image capture functionality and effectiveness. It also increases lots of inconvenience for users to manually input the instruction through the manual control unit 60. Consequently, the CCTV camera systems of prior art do not meet users' requirements in practical application.

### SUMMARY OF THE INVENTION

Accordingly, a primary objective of the present invention is to provide an adaptive CCTV camera system that is equipped with a structural configuration comprising an optical sensing unit, an image processing unit, an optical lens set, a microprocessor, a memory unit and at least one automatic control unit, which enables the microprocessor to receive at least one environment-sensing signal from the automatic control unit and to read the characteristic value from the output of the image processing unit, and then generates the correction values toward the operating parameters, for example: Iris, electronic shutter, AWB (Automatic White balance), . . . etc. through the logic programming operation processed in the microprocessor. Consequently, the correction values are combined with those pre-specified parameters stored in the memory unit to form an optimum set of operating parameters and to provide a function of real-time automatic adjustment of pre-specified operating parameters for further utilization. Therefore, the adaptive CCTV camera system is eligible to be used in a variety of environmental conditions to achieve stable image capture functionality, thereby enhancing practicality of the present invention.

In order to fulfill the aforementioned objectives, the adaptive CCTV camera system of the present invention comprises the optical sensing unit, the image processing unit, the optical lens set, the microprocessor, the memory unit and at least one automatic control unit. The optical sensing unit is an image sensor comprising devices capable to convert optical signals into electronic signals, enables image capture. The image processing unit processes image signals received from the image sensing unit, performs functions of AGC (Auto Gain Control), AWB (Auto White Balance), . . . etc., and produces image output. Moreover, the image processing unit provides the image sensing unit with control signals to perform adjustment of operational parameters. The optical lens set projects external optical signals to the image sensing unit, is connected to the image processing unit to enable optical parameters adjusting. The microprocessor is respectively connected with the image processing unit and at least one automatic control unit to execute the logic program coded therein and to generate the adjusting information to the image processing unit as a correcting reference toward the pre-specified operating parameters. The memory unit is used to store a set of pre-specified parameters and is respectively connected to the microprocessor and the image processing unit to form a data linkage.

Such a configuration enables the adaptive CCTV camera system to be equipped with a real-time function to automatically adjust pre-specified operating parameters without manual adjustments, and proves the present invention can be applied in a variety of environmental conditions, and achieves stable image capture functionality and effectiveness.

To provide a further understanding of said objective and the technological methods of the invention herein, brief description of the drawings is provided below followed by detailed description of the preferred embodiments.

### BRIEF DESCRIPTION OF THE DRAWINGS

FIG. 1 shows a block schematic diagram depicting a CCTV camera system of prior art.

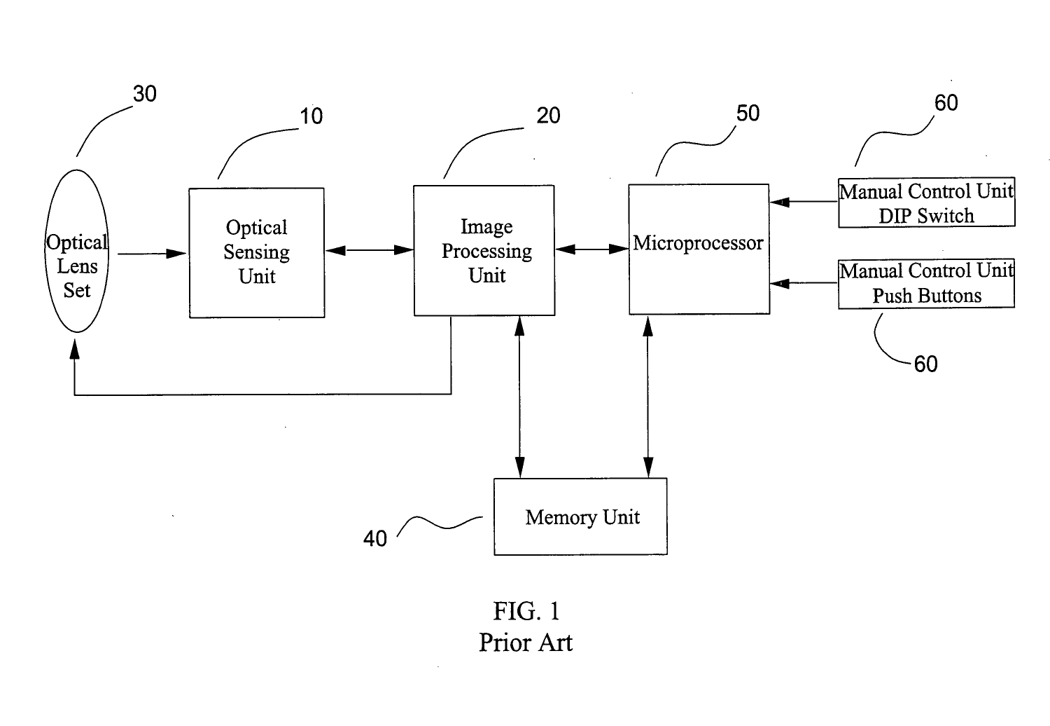

FIG. 2 shows a block schematic diagram depicting the adaptive CCTV camera system according to the present invention.

### DETAILED DESCRIPTION OF THE PREFERRED EMBODIMENTS

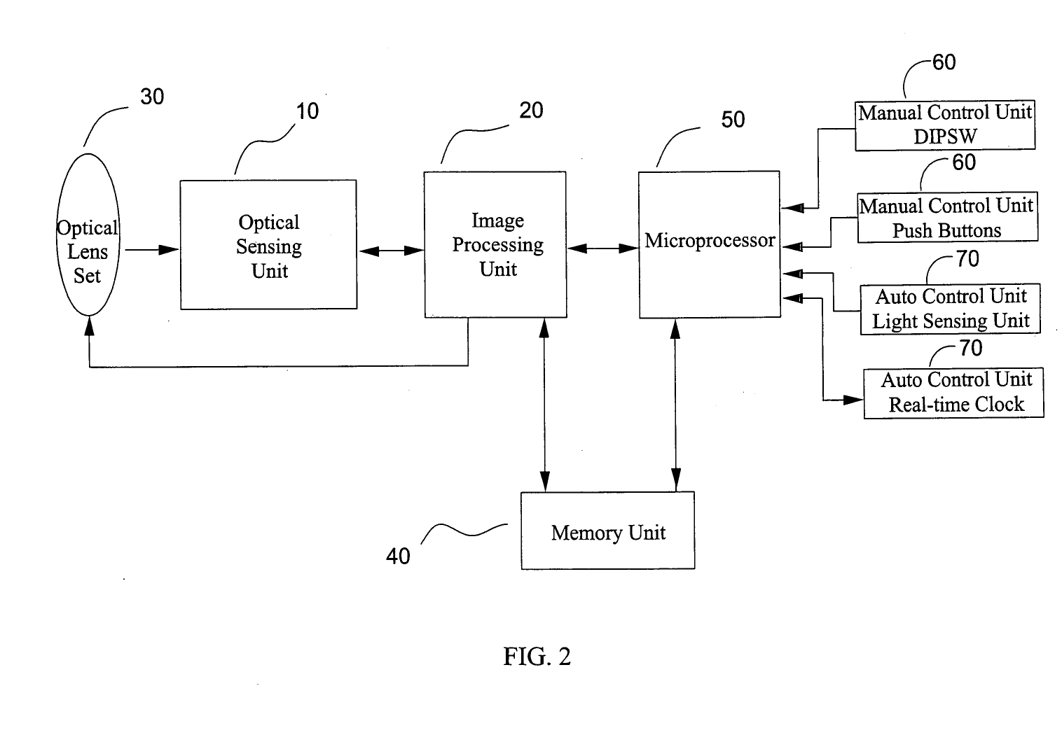

Referring to FIGS. 2, which shows an adaptive CCTV camera system of the present invention, comprising:

An image sensing unit 10 that is an image sensor device able to convert optical signals into electronic signals provides image capture.

An image processing unit 20 processes image signals received from the image sensing unit 10 and produces image output therefrom. Moreover, the image processing unit 20 provides the image sensing unit 10 control signals to fulfill the adjustment of operating parameters.

An optical lens set 30 projects optical signals to the image sensing unit 10, and is connected to the image processing unit 20 to enable optical parameters adjusting.

A microprocessor 50 that is respectively connected with the image processing unit 20 and at least one automatic control unit 70, wherein the automatic control unit 70 is light sensing unit that transmits control signals to the microprocessor 50 according to luminance response of external environmental conditions. Moreover, the automatic control units 70 can be real-time clock with functions of time-reporting and synchronization, and other units able to generate automatic signals. Besides, the microprocessor 50 reads the characteristic value of the output from the image processing unit 20 and receives at least one self-generated signal from automatic control unit 70 to execute the logic program coded therein and to output the adjusting information to the image processing unit 20 as a correcting reference toward the pre-specified operating parameters.

A memory unit 40 provides storing a set of pre-specified parameters and is respectively connected to the microprocessor and the image processing unit to form a data linkage.

Accordingly, referring to FIGS. 2, which shows the adaptive CCTV camera system of the present invention characterized in that it is structurally configured to comprise the aforementioned devices, including the image sensing unit 10, the image processing unit 20, the optical lens set 30, the memory unit 40, the microprocessor 50 and the at least one automatic control unit 70. The microprocessor 50, by means of at least one automatic control unit 70 (such as: light sensing unit, real-time clock, and so on) connected thereto, is able to separately output a plurality of automatic control signals to the microprocessor 50 according to users' requirements or a variety of different external environmental conditions, thereafter those control signals generated from at least one automatic control unit 70 and the characteristic value of output from image processing unit 20 are processed according to the logic program coded in the microprocessor 50. Consequently, it generates the adjusting information to the image processing unit 20 as a correcting reference toward the pre-specified operating parameters. Furthermore, the correction values are combined with the pre-specified parameters to form an optimum set of operating parameters for further utilization. Therefore, the adaptive CCTV camera system is eligible to be used in a variety of environmental conditions to achieve stable image capture functionality and fit users' practical requirements without manual adjustments, thereby enhancing practicality of the present invention. Hence, the present invention facilitates use in a variety of external environmental conditions, and provides simple operation and stable image capture functionality and effectiveness.

It is, of course, to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An adaptive CCTV (Closed Circuit Television) camera system, comprising:
an optical sensing unit that is able to convert optical signals into electronic signals to enable image capture;
an image processing unit that processes image signals received from the optical sensing unit and outputs images, moreover, the image processing unit provides the image sensing unit with the adjustment of operational parameters;
an optical lens set that projects optical signals to the image sensing unit, and is connected to the image processing unit to enable optical parameters adjusting;
a microprocessor that is respectively connected with the image processing unit and at least one automatic control unit to automatically generate the adjusting information toward the pre-specified operating parameters; and
a memory unit that provides for storing a sets of pre-specified parameters and is respectively connected to the microprocessor and the image processing unit to form a data linkage.

2. The adaptive CCTV camera system according to claim 1, wherein the automatic control unit is a light sensing unit.

3. The adaptive CCTV camera system according to claim 1, wherein the automatic control unit is a real-time clock.
